(19) United States
(12) Patent Application Publication
(10) Pub. No.: US 2021/0209525 A1
(43) Pub. Date: Jul. 8, 2021

(54) PREDICTION-BASED VEHICLE RESERVATION SYSTEMS

(71) Applicant: Volvo Car Corporation, Göteborg (SE)

(72) Inventors: Nils Gunnar Oppelstrup, Stockholm (SE); Mikael Gunnar Löthman, Stockholm (SE); Tom Baylis, Stockholm (SE); Baptiste Rousset, Stockholm (SE)

(21) Appl. No.: 17/251,152

(22) PCT Filed: Jun. 12, 2019
(86) PCT No.: PCT/IB2019/054925

§ 371 Date: Dec. 10, 2020

Related U.S. Application Data
(60) Provisional application No. 62/683,665, filed on Jun. 12, 2018.
(60) Provisional application No. 62/841,425, filed on May 1, 2019.

(51) Int. Cl. G06Q 10/02; G06Q 10/06; G06Q 30/02; G06Q 50/30

(52) U.S. Cl. CPC G06Q 10/02; G06Q 50/30; G06Q 30/0282; G06Q 10/06315

(57) ABSTRACT

In general, this disclosure describes mobile asset management. Examples of this disclosure are directed to predicting a preferred mobile asset pickup location. A computing system of this disclosure includes an interface, a memory, and processing circuitry in communication with the interface and the memory. The processing circuitry is configured to receive, via the interface, an indication of a mobile asset reservation system being invoked in association with a user identity, to generate a mobile asset reservation based on one or more predicted mobile asset reservation attributes associated with the user identity, and to store the mobile asset reservation to the memory.

This application claims the benefit of Provisional U.S. Patent Application No. 62/841,425 filed on 1 May 2019 and Provisional U.S. Patent Application No. 62/683,665 filed on 12 Jun. 2018, the entire content of each of which is incorporated herein by reference.

### BACKGROUND

Users of shared mobile asset platforms often place bookings from locations that do not accurately reflect the users' planned location at the time of the booking. For example, a user may place a vehicle booking request from home, but plan to pick up the vehicle close to the user's place of work. Reservation systems that rely solely on the physical or logical location of the user-facing device from the reservation request originates may not always accurately predict the details of the reservation itself, such as the planned vehicle pickup location, the planned time of pickup, etc. In such instances, default options that are auto-populated or recommended to the user may need one or even numerous corrections to bring the reservation in line with the user's intent. Solutions that rely on a single or multiple user-provided corrections to align the reservation with the user's intent consume bandwidth and expend computing resources between the original reservation invocation and the intake of a completed reservation request that aligns with the user's intent.

### SUMMARY

Systems and techniques of this disclosure are directed to mobile asset management. In various examples, this disclosure describes techniques for predicting a preferred mobile asset pickup location. Some aspects of this disclosure leverage historical data to generate recommendations and/or default options that are presented to a user when the user logs into or invokes a mobile asset reservation interface via connected computing device. For example, the systems of this disclosure may custom-generate a mobile asset reservation suggestions for a user that includes a suggested mobile asset pickup location determined based on one or more of transportation information or historical user information.

In some examples, the systems of this disclosure may use heuristic data associated with a user identifier that was used to invoke the reservation interface to generate the default reservation options. Based on past reservations placed under the instant user identifier, the systems of this disclosure populate reservation fields, such as vehicle pickup time, pickup location, and vehicle type with default options that match the user's most common and/or most recent selections over a prior period of time.

In one aspect, this disclosure is directed to a method. The method includes receiving, by a computing system, an indication of a mobile asset reservation system being invoked in association with a user identity. The method further includes generating, by the computing system, a mobile asset reservation based on one or more predicted mobile asset reservation attributes associated with the user identity.

In another aspect, this disclosure is directed to an apparatus. The apparatus includes means for receiving an indication of a mobile asset reservation system being invoked in association with a user identity. The apparatus further includes means for generating a mobile asset reservation based on one or more predicted mobile asset reservation attributes associated with the user identity.

In another aspect, this disclosure is directed to a computing system that includes an interface, a memory, and processing circuitry in communication with the interface and the memory. The processing circuitry is configured to receive, via the interface, an indication of a mobile asset reservation system being invoked in association with a user identity. The processing circuitry is further configured to generate a mobile asset reservation based on one or more predicted mobile asset reservation attributes associated with the user identity. The processing circuitry is further configured to store the mobile asset reservation to the memory.

In this way, the systems of this disclosure may provide improved data precision, in that reservations are initiated based on a user's own vehicle pickup history, and not purely on user preference-agnostic data, such as the current location of the computing device via which the user invoked the reservation interface. As such, the systems of this disclosure may recommend pickup locations that are not the closest or have the shortest travel time from the user's present location, based on the particular user exhibiting a preference for a different pickup location as evidenced by historical pickup location selections, as one example. Additionally, the systems of this disclosure may mitigate computing resource usage in some instances by reducing the number of instances in which data is transmitted (whether from user to server or vice versa) in order to correct reservations if the default reservation facets are generated purely on device location without factoring in the particular user's reservation history.

The details of one or more examples of this disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system of this disclosure, in which a server device communicates via a wireless network with multiple automobiles and with a user-facing device.

FIG. 2 is a conceptual diagram illustrating an example user interface of this disclosure.

FIG. 3 is a block diagram illustrating an example apparatus configured to perform various techniques of this disclosure.

FIG. 4 is a flowchart illustrating an example process that a computing system may perform, in accordance with one example of the disclosure.

### DETAILED DESCRIPTION

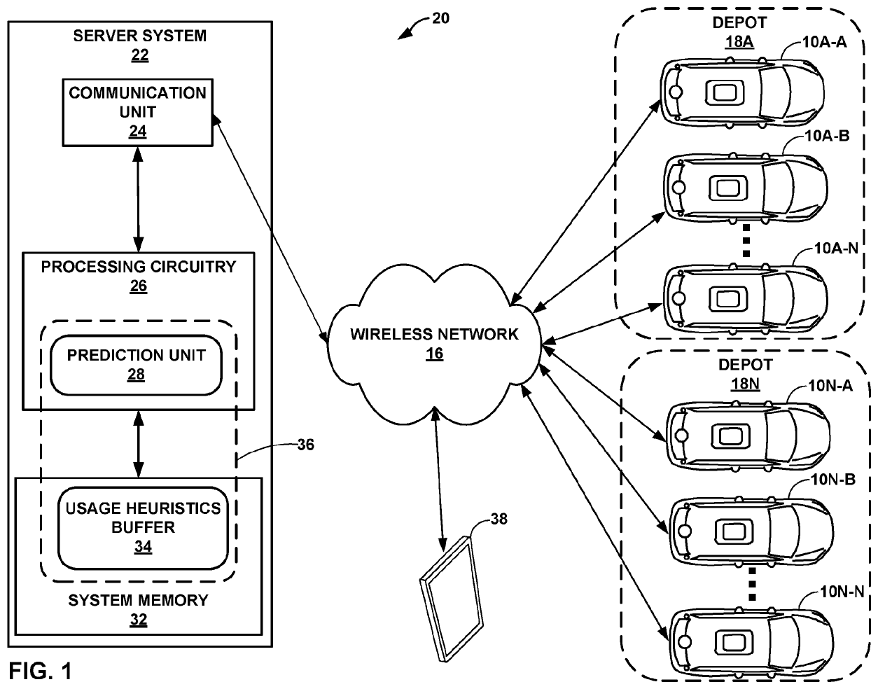

FIG. 1 is a block diagram illustrating an example system 20 of this disclosure, in which a server system 22 communicates via a wireless network 16 with multiple vehicles 10A-A to 10N-N (collectively “vehicles 10”) and device 38. Each of vehicles 10 includes communication hardware that enables the respective vehicle 10 communicate with server system 22 via wireless network 16. For instance, each of vehicles 10 may be equipped with telematics hardware, thereby integrating one or more of telecommunications, vehicular technologies (e.g., road transportation, road safety, electrical equipment such as sensors, instrumentation, wireless communications hardware, etc.), and computing equipment (e.g. multimedia technology, network connectivity via the Internet, etc.).

FIG. 1 illustrates an implementation of the techniques of this disclosure that provides configurations for both a user-facing device (e.g. a browser interface or a mobile application) as well as a backend server that work in tandem to implement asset reservations and bookings, and ultimately provide the user access to a reserved vehicle. Server system 22 of this disclosure leverages heuristic data and, in some examples, real-time traffic data to generate, update, or recommend certain reservation facets. User-facing device 38 outputs these reservation facets via one or more elements of a user interface (UI), and receives user inputs with regards to the reservation (e.g., further changes, acceptances, cancellations, etc.) from the user via the UI. User-facing device 38 relays information drawn from the received user input(s) to the backend server, enabling server system 22 to finalize, confirm, and hold the reservation.

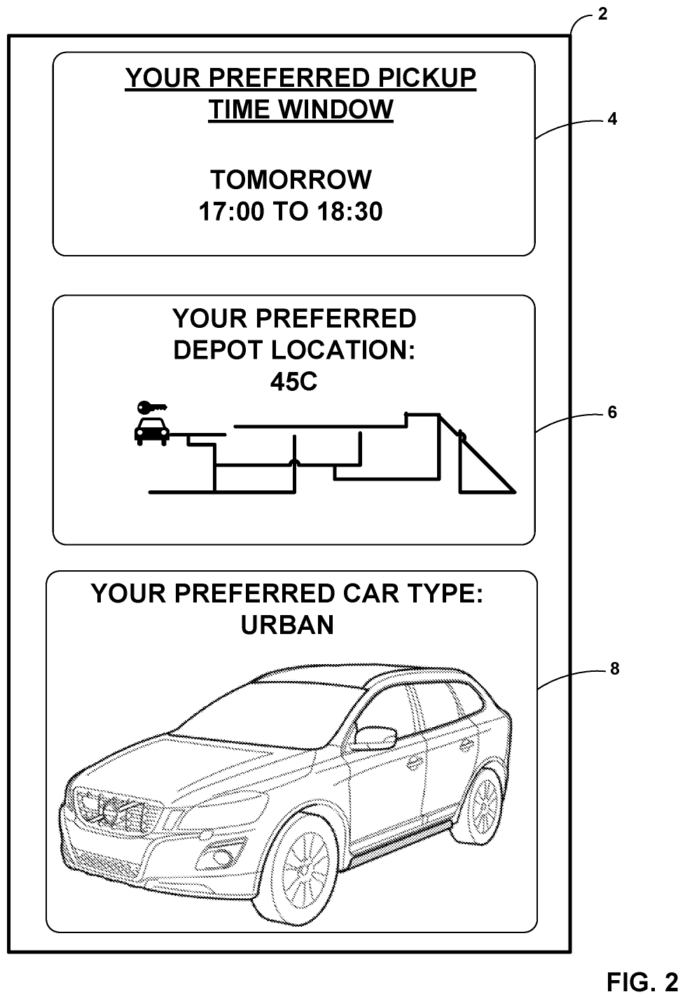

System 20 represents an example in which the techniques of this disclosure are implemented in a network-driven system, and in some cases by implementing machine learning (ML). Server system 22 may, in some examples, be included in a cloud computing system and may represent one server system included in such a cloud computing system, which may potentially include multiple server systems. Server system 22 facilitates the cloud-based implementations of the techniques of this disclosure with respect to reservations with reservations for vehicles 10. In the example of FIG. 2, server system 22 receives the reservation requests from user-facing device 38. Server system 22 implements the cloud-based techniques of this disclosure to manage reservations for mobile assets, namely, vehicles 10 in this example. Server system 22 represents a portion or the entirety of a cloud-based system for ML-based asset management.

Server system 22 implements various aspects of this disclosure to gather and process information pertaining to vehicles 10 and their expected checkout and return to respective depots 18A-18N (collectively, “depots 18”). Server system 22 may also generate predictive data that can be used to generate default reservation requests to provide to user-facing device 38 for user acceptance or user-initiated edits. While some of the recommendations generated by server system 22 may appear sub-optimal from the perspective of distance or travel time from the current location of user-facing device 38, server system 22 may provide these recommendations based on the logged-in user identity exhibiting a history of pickup location preferences at another location (e.g., a place of work, a restaurant or café, a public transit station, or other location) that the user frequents and from where the user reserves vehicles for usage. For instance, server system 22 uses communication unit 24 to receive and transmit information via over wireless network 16. It will be appreciated that communication unit 24 may equip server system 22 with an either a direct interface or a transitive interface to wireless network 16. In cases where communication unit 24 represents a direct interface to wireless network 16, communication unit 24 may include, be, or be part of various wireless communication hardware, including, but not limited to, one or more of Bluetooth®, 3G, 4G, 5G, or WiFi® radios. In cases where communication unit 24 represents a first link in a transitive interface to wireless network 16, communication unit 24 may represent wired communication hardware, wireless communication hardware (or some combination thereof), such as any one or any combination of a network interface card (e.g, an Ethernet card and/or a WiFi® dongle), USB hardware, an optical transceiver, a radio frequency transceiver, Bluetooth®, 3G, 4G, 5G, or WiFi® radios, and so on. Wireless network 16 may also enable the illustrated devices to communicate GPS and/or dGPS, such as location information of one or more of vehicles 10.

While communication unit 24 is illustrated as a single, standalone component of server system 22, it will be appreciated that, in various implementations, communication unit 24 may form multiple components, whether linked directly or indirectly. Moreover, portions of communication unit 24 may be integrated with other components of server system 22. At any rate, communication unit 24 represents network hardware that enables server system 22 to reformat data (e.g., by packetizing or depacketizing) for communication purposes, and to signal and/or receive data in various formats over wireless network 16.

Wireless network 16 may comprise aspects of the Internet or another public network. While not explicitly shown in FIG. 1 for ease of illustration purposes, wireless network 16 may incorporate network architecture comprising various intermediate devices that communicatively link server system 22 to one or more of vehicles 10. Examples of such devices include wireless communication devices such as cellular telephone transmitters and receivers, WiFi® radios, GPS transmitters, etc. Moreover, it will be appreciated that while wireless network 16 delivers data to vehicles 10 and collects data from vehicles 10 using wireless “last mile” components, certain aspects of wireless network 16 may also incorporate tangibly-connected devices, such as various types of intermediate-stage routers.

Communication unit 24 of server system 22 is communicatively coupled to processing circuitry 26 of server system 22. Processing circuitry 26 may be formed in one or more microprocessors, application specific integrated circuits (ASICs), field programmable gate arrays (FPGAs), digital signal processors (DSPs), fixed function circuitry, programmable processing circuitry, various combinations of fixed function circuitry with programmable processing circuitry, or other equivalent integrated logic circuitry or discrete logic circuitry. Fixed-function circuitry refers to circuits that provide particular functionality and are preset on the operations that can be performed. Programmable processing circuitry refers to circuits that can programmed to perform various tasks and provide flexible functionality in the operations that can be performed. For instance, programmable processing circuitry may represent hardware that executes software or firmware that cause programmable circuits to operate in the manner defined by instructions of the software or firmware. Fixed-function circuitry may execute software instructions (e.g., to receive parameters or output parameters), but the types of operations that the fixed-function processing circuits perform are generally immutable. In some examples, one or more of the units may be distinct circuit blocks (fixed-function or programmable), and in some examples, the one or more units may be integrated circuits. As shown in FIG. 2, processing circuitry 26 is communicatively coupled to system memory 32 of server system 22.

System memory 32, in some examples, are described as a computer-readable storage medium and/or as one or more computer-readable storage devices. In some examples, system memory 32 may include, be, or be part of temporary memory, meaning that a primary purpose of system memory 32 is not long-term storage. System memory 32, in some examples, is described as a volatile memory, meaning that system memory 32 do not maintain stored contents when the computer is turned off. Examples of volatile memories include random access memories (RAM), dynamic random access memories (DRAM), static random access memories (SRAM), and other forms of volatile memories known in the art.

In some examples, system memory 32 are used to store program instructions for execution by processing circuitry 26. System memory 32, in one example, are used by logic, software, or applications implemented at server system 22 to temporarily store information during program execution. System memory 32, in some examples, also include one or more computer-readable storage media. Examples of such computer-readable storage media may include a non-transitory computer-readable storage medium, and various computer-readable storage devices. System memory 32 may be configured to store larger amounts of information than volatile memory. System memory 32 may further be configured for long-term storage of information. In some examples, system memory 32 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

One or more of vehicles 10 may represent vehicles configured to automate one or more tasks associated with vehicle operation. In some examples, one or more of vehicles 10 may be capable of automating some, if not all of the tasks associated with vehicle operation except for providing input related to destination selection. It will be appreciated that some of vehicles 10 may be capable of automating various tasks in some scenarios, although not every vehicle of vehicles 10 may implement automation of each function at all times, and in some use case scenarios, none of vehicles 10 may incorporate automation functionalities. In some instances, one or more of vehicles 10 may disable the automation of certain tasks, e.g., based on a user input to instigate such a disabling of one or more operation tasks, or may not be equipped with these automation functionalities at all. In this way, the systems of this disclosure are compatible with various types of vehicles, including vehicles that incorporate varying degrees of automation, as well as telematics-equipped vehicles that are driven by driver input according to more traditional driving technology.

Vehicles 10 are assumed in the description below as passenger cars, although aspects of this disclosure may apply to any type of vehicle capable of conveying one or more occupants and operating autonomously, such as buses, recreational vehicles (RVs), semi-trailer trucks, tractors or other types of farm equipment, trains, motorcycles, personal transport vehicles, and so on. Each of vehicles 10 is equipped with communication logic and interface hardware, by which each of each of vehicles 10 may send and receive data over wireless network 16.

One or more of vehicles 10 may transmit or “upload” location, speed, and other information to server system 22 via wireless network 16, using the telematics functionalities with which vehicles 10 are equipped. For instance, communication unit 24 may receive data packets from one or more of vehicles 10. Communication unit 24 may decapsulate the packets to obtain respective payload information of the packets. In turn, communication unit 24 may forward the payloads to processing circuitry 26. In these and other examples, communication unit 24 may receive information regarding traffic conditions, user statistics, etc. from other sources, such as publicly-available information from the Internet, from other user-facing devices operated by other users, etc.

Processing circuitry 26 may implement further processing of the payload data of the packets received from vehicles 10 and the other sources described above. For instance, processing circuitry 26 may determine whether or not a particular payload is pertinent to vehicle 10A-A, or to vehicle 10A-B, to an identity of a user currently driving or schedule to pick up one of vehicles 10, etc. Additionally, processing circuitry 26 may store portions of decapsulated, processed payloads to system memory 32. In some specific examples, processing circuitry 26 may store the selected portions of the processed payloads to usage heuristics buffer 34, which is implemented in system memory 32.

Server system 22 is configured to receive and store availability and location information for vehicles 10, and to communicate portions of information to user-facing device 38. Processing circuitry 26 of server system 22 implements various techniques of this disclosure to analyze and update or analyze and autogenerate default reservation information upon receiving a communication indicating that the reservation interface has been invoked on user-facing device 38. In turn, processing circuitry 26 may invoke communication unit 24 to transmit data representing the default reservation to user-facing device 38. In the example of FIG. 1, processing circuitry 26 includes a prediction unit 28. Processing circuitry 26 may invoke prediction unit 28 to generate predictive reservation information that correlates to reservation preferences associated with the user identity presently logged into the reservation interface via user-facing device 38.

In accordance with various aspects of this disclosure, prediction unit 28 may obtain data from usage heuristics buffer 34, and use the data to generate default reservation information. In some examples, prediction unit 28 may obtain, from usage heuristics buffer 34, information indicating past reservation information that was either proactively entered or reviewed and approved by the same user identity that is currently accessing the reservation interface via user-facing device 38. In some examples, prediction unit 28 may filter the historical data obtained from usage heuristics buffer 34 in order to form a tighter set of training data, such as by filtering the historical data for recency or based on other factors. Prediction unit 28 and usage heuristics buffer 34 are shown in FIG. 1 as collectively forming a scheduling engine 36. It will be appreciated that, under some use case scenarios, scheduling engine 36 may also draw on information available from sources other than usage heuristics buffer 34 in forming reservation updates.

The default reservations of this disclosure are also referred to at portions of this disclosure as “journey suggestions.” To improve or maintain conversion rate (e.g., the number of completed bookings based on projected user intent), scheduling engine 36 generates journey suggestions to include default options based on a projected intent gleaned from usage heuristics buffer 34. By generating as relevant journey suggestions as possible, scheduling engine 36 provides the technical enhancement of improving or maintaining conversion rates in the practical application of network-driven mobile asset management technology.

Scheduling engine 36 generates journey suggestions to include at least three features, namely, a pickup time window, a pickup location (corresponding to one of depots 18), and vehicle type. In some examples, scheduling engine 36 may also include a vehicle return or drop-off location (corresponding to one of depots 18) that may, but need not necessarily, be the same one of depots 18 that corresponds to the pickup location. In some examples, scheduling engine 36 may prioritize the parameters in the following order of most-important to least-important: 1. desired pickup time interval; 2. distance to the pickup/drop-off location; and 3. car type.

Scheduling engine 36 may implement one or more algorithms in hardware to provide server system 22 with these functionalities. One such algorithm that scheduling engine 36 may implement in hardware is represented by the following sequence of operations:
1. Find all matching slots in car schedule
a. Find all depots close to the position of the projected intent.
b. For all cars in the depots, find all free slots that match the reservation time interval. In some examples, the time interval corresponds to the time interval of the projected intent, with an extension of time in order to allow for non-exact matches when it comes to the time of vehicle pickup.
2. Only return exact matches if any exact matches were found. If exact matches were found (i.e. the exact time, location, and car type), all other results with partial matches will be ignored.
3. Merge matches (only one suggestion per car type and depot). All matches will be merged so that only one unique item identified on a per {time, depot, car type} 3-tuple will be suggested.
4. Sort based on distance. The match that is closest to the location of the intent will be first. This step is, in some examples, assigned the least weight, because, as described above, the user's preferred pickup or dropoff location is not necessarily correlated with proximity to the reservation-originating device, but is instead a reflection of a location from which the user expects to travel to a depot at a later time or date.

As shown by the algorithm described above, scheduling engine 36 may also tune the journey suggestion to better suit vehicle availability at the time interval of the projected intent. As such, scheduling engine 36 may, in some examples, output a journey suggestion to user-facing device 38 such that the journey suggestion represents the best-available reservation at the predicted time interval of the projected intent or at the closest-occurring time interval to the predicted time interval of the projected intent. Because the pickup time is ranked as the highest priority feature in this use case scenario, scheduling engine 36 forms the journey suggestions to match or include features as close as possible to the predicted reservation formed from the projected intent. Among those journey suggestions that match, or are sufficiently close to, the predicted pickup time window of the projected intent, scheduling engine 36 may perform a ranking operation that evaluates the depot location as a heavier-weighted criterion, and the car type as a lower-weighted criterion.

That is, if scheduling engine 36 detects that two journey suggestion candidates have the same or substantially the same pickup time windows, and that these two candidates also have the same depot location for pickup, then scheduling engine 36 may distinguish the two candidates and rank them based on their respective car types. If all three of these factors match, scheduling engine 36 may transmit only one instance of the duplicative journey suggestions to user-facing device 38, thereby presenting the user with unique choices rather than presenting a choice between duplicative journey suggestions.

FIG. 2 is a conceptual diagram illustrating an example user interface of this disclosure. FIG. 2 illustrates user interface (UI) 2, which represents a UI that systems of this disclosure may cause a user-facing device to output for display, to elicit user input for confirming or validating a default reservation request. UI 2 illustrates a use case scenario in which scheduling engine 36 selects and outputs a default 3-tuple of pickup time window, pickup location, and vehicle type for a particular user, based on heuristic data available for that particular user. UI 2 includes a time element 4, a location element 6, and a vehicle type element 8. In FIG. 2, time element 4 indicates a preferred time window for vehicle pickup, as determined by scheduling engine 36, based on the user's history or recent history. Location element 6 indicates a preferred depot for the vehicle pickup, as determined by scheduling engine 36, based on the user's history or recent history. Vehicle type element 8 indicates a preferred vehicle for the intended reservation, as determined by scheduling engine 36, based on the user's history or recent history.

In this way, scheduling engine 36 leverages the logged-in user's past vehicle booking history to generate a default reservation that is custom tailored to the user who invoked UI 2 via the mobile application or browser interface. By leveraging the user's vehicle checkout history and not relying purely on the physical/logical location of the user-facing device that outputs UI 2, scheduling engine 36 generates and outputs default reservations that produce a lower rate of user-initiated corrections, thereby improving data precision and reducing computing resource usage and bandwidth consumption associated with effecting such corrections. In instance where a user-initiated correction or update is indeed entered, scheduling engine 36 updates the heuristic (or “training”) data used for future reservations, thereby incorporating more recent updates into the generation of future default reservations for the particular user.

The systems of this disclosure may relay data to various types of client devices or user-facing devices to cause UI 2 to be output for display. In various examples, the user-facing device(s) that output UI 2 for display may include, be, or be part of one or more of a smartphone, a tablet computer, a laptop computer, a desktop computer, a television with interactive capabilities (e.g., a smart TV), a video gaming console paired with an appropriate display device, or any other device or combination of devices capable of receiving data from a user and receiving/transmitting data over a network, such as a local area network (LAN), a wide area network (WAN), an enterprise network, or a public network such as the Internet.

These user-facing devices (described as being user-facing device 38 of FIG. 1 as an example) may include various hardware components configured, whether individually or in combination, to output UI 2 for display. Examples of these hardware components include network interface hardware, processing circuitry, and one or more memory devices. The memory devices may store instructions for execution of one or more applications. The memory devices may include one or more computer-readable storage media (e.g., a non-transitory computer-readable storage medium), computer-readable storage devices, etc. Examples of memory devices include, but are not limited to, a random access memory (RAM), an electrically erasable programmable read-only memory (EEPROM), flash memory, or other medium that can be used to carry or store desired program code in the form of instructions and/or data structures and that can be accessed by a computer or one or more processors (e.g., the processing circuitry described above).

In some aspects, the memory devices may store instructions that cause the processing circuitry of user-facing device 38 to perform the functions ascribed in this disclosure to the processing circuitry. Accordingly, at least one of the memory devices may represent a computer-readable storage medium having instructions stored thereon that, when executed, cause one or more processors (e.g., the processing circuitry) to perform various functions. For instance, at least one of the memory devices is a non-transitory storage medium. The term “non-transitory” indicates that the storage medium is not embodied in a carrier wave or a propagated signal. However, the term “non-transitory” should not be interpreted to mean that the memory devices are non-movable or that the stored contents are static. As one example, at least one of the memory devices described herein can be removed from user-facing device 38, and moved to another device. As another example, memory, substantially similar to one or more of the above-described memory devices, may be inserted into one or more receiving ports of user-facing device 38. In certain examples, a non-transitory storage medium may store data that can, over time, change (e.g., in RAM).

The processing circuitry of user-facing device 38 may be formed in one or more microprocessors, application specific integrated circuits (ASICs), field programmable gate arrays (FPGAs), digital signal processors (DSPs), fixed function circuitry, programmable processing circuitry, any combination of fixed function circuitry and programmable processing circuitry, or other equivalent integrated logic circuitry or discrete logic circuitry. Fixed-function circuitry refers to circuits that provide particular functionality and are preset on the operations that can be performed. Programmable processing circuitry refers to circuits that can programmed to perform various tasks and provide flexible functionality in the operations that can be performed. For instance, programmable processing circuitry may represent hardware that executes software or firmware that cause programmable circuits to operate in the manner defined by instructions of the software or firmware. Fixed-function circuitry may execute software instructions (e.g., to receive parameters or output parameters), but the types of operations that the fixed-function processing circuits perform are generally immutable. In some examples, one or more of the units may be distinct circuit blocks (fixed-function or programmable), and in some examples, the one or more units may be integrated circuits.

Examples of network interface hardware that user-facing device 38 may incorporate include a direct interface or a transitive interface to a network, such as a wireless or wired network. In cases of a direct interface to a wireless network, such interface hardware may include, be, or be part of various wireless communication hardware, including, but not limited to, one or more of Bluetooth®, 3G, 4G, 5G, or WiFi® radios. In cases of a wired network or a first link in a transitive interface to a wireless network, the interfaces may incorporate wired communication hardware, wireless communication hardware (or some combination thereof), such as any one or any combination of a network interface card (e.g, an Ethernet card and/or a WiFi® dongle), USB hardware, an optical transceiver, a radio frequency transceiver, Bluetooth®, 3G, 4G, 5G, or WiFi® radios, and so on. User-facing device 38 may also communicate location information (e.g., in the form of GPS and/or dGPS coordinates, logical network addresses, etc.) to server system 22.

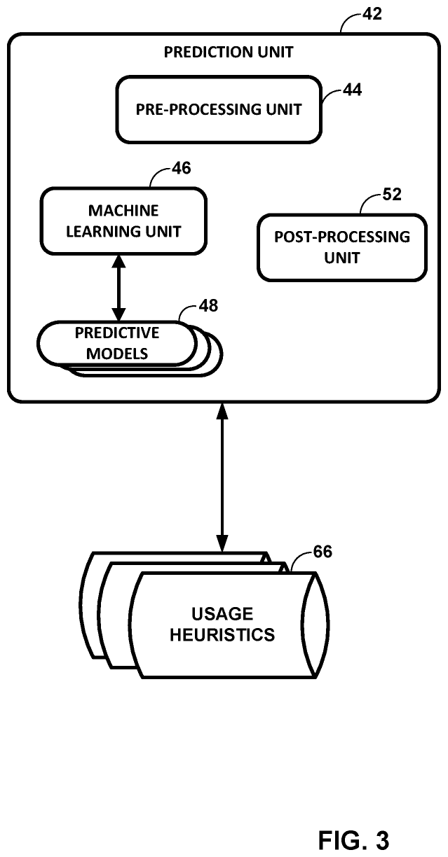

FIG. 3 is a block diagram illustrating an example apparatus configured to perform the techniques of this disclosure. In particular, FIG. 3 shows portions of server system 22 of FIG. 1 in more detail.

In the example of FIG. 3, prediction unit 42 includes a pre-processing unit 44, a machine learning unit 46, and a post-processing unit 52. Pre-processing unit 44 is configured to make the unstructured raw input (i.e., location information and/or the speed at which vehicle 10 is traveling) into structuralized data that can be processed by other components of prediction unit 42 and/or of computing system 14.

Pre-processing unit 44 may be configured to provide the structuralized data to machine learning unit 46. Machine learning unit 46 may implement various forms of machine learning technology, including, but not limited to, artificial neural networks, deep learning, support vector machine technology, Bayesian networks, etc. Using the structuralized data obtained from pre-processing unit 44, machine learning unit 46 may perform comparison operations with respect to predictive model 48. If machine learning unit 46 detects a discrepancy between any of the structuralized data received from pre-processing unit 44 and the road conditions reflected in predictive model 48, machine learning unit 46 may update the data of predictive model 48 to incorporate the more up-to-date availability information of depots 18. In this way, machine learning unit 46 implements dynamic model generation or model updating operations of this disclosure to use and to share updates to obsolete availability information regarding vehicles 10.

Post-processing unit 52 may obtain the updated version of predictive model 48, and convert the data of predictive model 48 into final output. For example, post-processing unit 52 may be configured to translate predictive model 48 into one or more machine-readable formats. In various examples, prediction unit 42 may provide the output generated by post-processing unit 52 to one or more display operation applications 56.

The instructions that define prediction unit 42 may be stored in a memory. In some examples, the instructions that define prediction unit 42 may be downloaded to the memory over a wired or wireless network. In some examples, the memory may be a temporary memory, meaning that a primary purpose of the memory is not long-term storage. The memory 64 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

The memory may include one or more non-transitory computer-readable storage mediums. The memory may be configured to store larger amounts of information than typically stored by volatile memory. The memory may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Memory 64 may store program instructions (e.g., prediction unit 42) and/or information (e.g., predictive model(s) 48) that, when executed, cause the processing circuitry to perform the techniques of this disclosure.

As shown, prediction unit 42 may generate one or more predictive models 48 by drawing on information from usage heuristics 66, which is illustrated as being implemented in a remote store in FIG. 3. One or more predictive models 48 represent scheduling information with default settings or suggestions, as described above in greater detail.

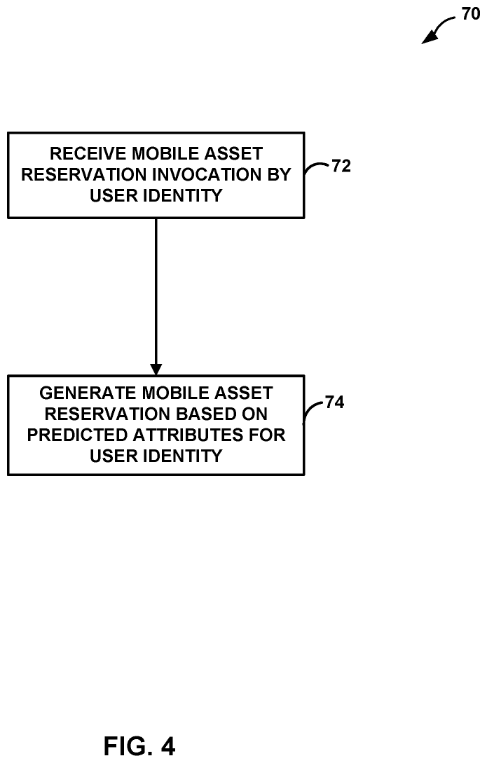

FIG. 4 is a flowchart illustrating an example process 70 that server system 22 may perform, in accordance with one example of the disclosure. One or more processors, such as processing circuitry 26 of server system 22 may be configured to perform the techniques shown in FIG. 4. Process 70 is described herein as being performed by scheduling engine 36 formed in processing circuitry 26 and system memory 32 of server system 22.

In accordance with process 70 of FIG. 4, scheduling engine 36 may receive an indication that a mobile asset reservation system has been invoked, in association with a user identity (72). For example, scheduling engine 36 may receive data via communication unit 24 indicating that the mobile asset reservation system was invoked at user-facing device 38 by the presently logged-in user identity. As examples, the mobile asset reservation system may be invoked by accessing a website via browser, or by invoking a mobile application (or “app”) using user-facing device 38.

In turn, scheduling engine 36 may generate a mobile asset reservation based on one or more predicted mobile asset reservation attributes associated with the user identity (74). For example, scheduling engine 36 may utilize heuristic data associated with the user identity in generating the mobile asset reservation. Scheduling engine 36 may identify a preferred depot location from the heuristic data. While the preferred depot location may not represent the physically closest or most easily accessible pickup location in comparison to the present location of user-facing device 38, scheduling engine 36 may select the location based on past reservations placed in association with the user identity. As such, the predicted depot location may represent a location that is closest to a work, transit, or social venue that the user frequents at the time the user chooses to pick up a vehicle. In some examples, scheduling engine 36 may filter the heuristic data to bias the prediction in favor of recency. For instance, prediction unit 28 may filter the heuristic data available from usage heuristics buffer 34 based on recency, to obtain a subset of the heuristic data. By using the obtained subset of the heuristic data for the user identity, scheduling engine 36 may generate the mobile asset reservation using predicted mobile asset reservation attributes that correlate to the user's recent habits or daily routines.

Examples of the predicted mobile asset reservation attributes include, but are not limited to, a reservation time interval, a vehicle location, or a vehicle type. Scheduling engine 36 may prioritize these attributes differently in choosing a journey suggestion, or in ranking a multitude of journey suggestion candidates. That is, in some examples, scheduling engine 36 generates a plurality of mobile asset reservations, of which the aforementioned mobile asset reservation is one. To prioritize the attributes above, scheduling engine 36 may implement a weighting system. In some examples, scheduling engine 36 may assign the greatest weight to the reservation time interval attribute, a middle weight to the vehicle location attribute, and a lightest weight to the vehicle type attribute. In other examples, scheduling engine 36 may assign the greatest weight to the reservation time interval attribute, a middle weight to the vehicle type attribute, and a lightest weight to the vehicle location attribute. Scheduling engine 36 may determine the weight assignments based on the heuristic data (or subset thereof, after filtering for recency and controlling for stale data), based on system attributes of the mobile asset reservation system, or other factors.

### Example 1

A method comprising: receiving, by a computing system, an indication of a mobile asset reservation system being invoked in association with a user identity; and generating, by the computing system, a mobile asset reservation based on one or more predicted mobile asset reservation attributes associated with the user identity.

### Example 2

The method of Example 1, wherein the one or more predicted mobile asset reservation attributes include one or more of a reservation time interval, a vehicle location, or a vehicle type.

### Example 3

The method of Example 2, wherein the mobile asset reservation is a first mobile asset reservation, and wherein generating the first mobile asset reservation comprises generating a plurality of mobile asset reservations that includes the first mobile asset reservation.

### Example 4

The method of Example 3, further comprising ranking, by the computing system, the respective mobile asset reservations of the plurality.

### Example 5

The method of Example 4, wherein ranking the respective mobile asset reservations comprises ranking the respective mobile asset reservations by assigning a first weight to the respective reservation time interval attributes, a second weight to the respective vehicle location attributes, and a third weight to the vehicle type attributes, wherein the first weight is greater than the second weight, and wherein the second weight is greater than the third weight.

### Example 6

The method of any of Examples 1-5, further comprising generating the predicted mobile asset reservation attributes using heuristic data associated with the user identity.

### Example 7

The method of Example 6, wherein the heuristic data associated with the user identity is a subset of available heuristic data available with respect to the user identity.

### Example 8

The method of Example 7, further comprising obtaining the subset by filtering the available heuristic data based on recency.

### Example 9

A computing system comprising: an interface; a memory; and processing circuitry in communication with the interface and the memory, the processing circuitry being configured to: receive, via the interface, an indication of a mobile asset reservation system being invoked in association with a user identity; generate a mobile asset reservation based on one or more predicted mobile asset reservation attributes associated with the user identity; and store the mobile asset reservation to the memory.

### Example 10

The computing system of Example 9, wherein the one or more predicted mobile asset reservation attributes include one or more of a reservation time interval, a vehicle location, or a vehicle type.

### Example 11

The computing system of Example 10, wherein the mobile asset reservation is a first mobile asset reservation, and wherein to generate the first mobile asset reservation, the processing circuitry is configured to generate a plurality of mobile asset reservations that includes the first mobile asset reservation.

### Example 12

The computing system of Example 11, wherein the processing circuitry is further configured to rank the respective mobile asset reservations of the plurality.

### Example 13

The computing system of Example 12, wherein to rank the respective mobile asset reservations, the processing circuitry is configured to rank the respective mobile asset reservations by assigning a first weight to the respective reservation time interval attributes, a second weight to the respective vehicle location attributes, and a third weight to the vehicle type attributes, wherein the first weight is greater than the second weight, and wherein the second weight is greater than the third weight.

### Example 14

The computing system of any of Examples 9-13, wherein the processing circuitry is further configured to generate the predicted mobile asset reservation attributes using heuristic data stored to the memory, the heuristic data being associated with the user identity.

### Example 15

The computing system of Example 14, wherein the heuristic data associated with the user identity is a subset of available heuristic data available from the memory with respect to the user identity.

### Example 16

The computing system of Example 15, wherein the processing circuitry is further configured to obtain the subset from the memory by filtering the available heuristic data based on recency.

### Example 17

The computing system of any of Examples 9-16, wherein the processing circuitry is further configured to transmit, via the interface, the mobile asset reservation to a remote device.

### Example 18

An apparatus comprising: means for receiving an indication of a mobile asset reservation system being invoked in association with a user identity; and means for generating a mobile asset reservation based on one or more predicted mobile asset reservation attributes associated with the user identity.

### Example 19

A non-transitory computer-readable storage medium encoded with instructions that, when executed, cause processing circuitry of a computing device to: receive an indication of a mobile asset reservation system being invoked in association with a user identity; and to generate a mobile asset reservation based on one or more predicted mobile asset reservation attributes associated with the user identity.

### Example 20

The non-transitory computer-readable storage medium of Example 19, wherein the one or more predicted mobile asset reservation attributes include one or more of a reservation time interval, a vehicle location, or a vehicle type.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable data storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including an integrated circuit (IC) or a set of ICs (e.g., a chip set). Various components, modules, or units are described in this disclosure to emphasize functional aspects of devices configured to perform the disclosed techniques, but do not necessarily require realization by different hardware units.

Various examples of the invention have been described. These and other examples are within the scope of the following claims.

1. A method comprising:
receiving, by a computing system, an indication of a mobile asset reservation system being invoked in association with a user identity; and
generating, by the computing system, a mobile asset reservation based on one or more predicted mobile asset reservation attributes associated with the user identity.

2. The method of claim 1, wherein the one or more predicted mobile asset reservation attributes include one or more of a reservation time interval, a vehicle location, or a vehicle type.

3. The method of claim 2, wherein the mobile asset reservation is a first mobile asset reservation, and wherein generating the first mobile asset reservation comprises generating a plurality of mobile asset reservations that includes the first mobile asset reservation.

4. The method of claim 3, further comprising ranking, by the computing system, the respective mobile asset reservations of the plurality.

5. The method of claim 4, wherein ranking the respective mobile asset reservations comprises ranking the respective mobile asset reservations by assigning a first weight to the respective reservation time interval attributes, a second weight to the respective vehicle location attributes, and a third weight to the vehicle type attributes, wherein the first weight is greater than the second weight, and wherein the second weight is greater than the third weight.

6. The method of claim 1, further comprising generating the predicted mobile asset reservation attributes using heuristic data associated with the user identity.

7. The method of claim 6, wherein the heuristic data associated with the user identity is a subset of available heuristic data available with respect to the user identity.

8. The method of claim 7, further comprising obtaining the subset by filtering the available heuristic data based on recency.

9. A computing system comprising:
an interface;
a memory; and
processing circuitry in communication with the interface and the memory, the processing circuitry being configured to:
receive, via the interface, an indication of a mobile asset reservation system being invoked in association with a user identity;
generate a mobile asset reservation based on one or more predicted mobile asset reservation attributes associated with the user identity; and
store the mobile asset reservation to the memory.

10. The computing system of claim 9, wherein the one or more predicted mobile asset reservation attributes include one or more of a reservation time interval, a vehicle location, or a vehicle type.

11. The computing system of claim 10, wherein the mobile asset reservation is a first mobile asset reservation, and wherein to generate the first mobile asset reservation, the processing circuitry is configured to generate a plurality of mobile asset reservations that includes the first mobile asset reservation.

12. The computing system of claim 11, wherein the processing circuitry is further configured to rank the respective mobile asset reservations of the plurality.

13. The computing system of claim 12, wherein to rank the respective mobile asset reservations, the processing circuitry is configured to rank the respective mobile asset reservations by assigning a first weight to the respective reservation time interval attributes, a second weight to the respective vehicle location attributes, and a third weight to the vehicle type attributes, wherein the first weight is greater than the second weight, and wherein the second weight is greater than the third weight.

14. The computing system of claim 9, wherein the processing circuitry is further configured to generate the predicted mobile asset reservation attributes using heuristic data stored to the memory, the heuristic data being associated with the user identity.

15. The computing system of claim 14, wherein the heuristic data associated with the user identity is a subset of available heuristic data available from the memory with respect to the user identity.

16. The computing system of claim 15, wherein the processing circuitry is further configured to obtain the subset from the memory by filtering the available heuristic data based on recency.

17. The computing system of claim 9, wherein the processing circuitry is further configured to transmit, via the interface, the mobile asset reservation to a remote device.

18. An apparatus comprising:
means for receiving an indication of a mobile asset reservation system being invoked in association with a user identity; and
means for generating a mobile asset reservation based on one or more predicted mobile asset reservation attributes associated with the user identity.

19. A non-transitory computer-readable storage medium encoded with instructions that, when executed, cause processing circuitry of a computing device to:
receive an indication of a mobile asset reservation system being invoked in association with a user identity; and
generate a mobile asset reservation based on one or more predicted mobile asset reservation attributes associated with the user identity.

20. The non-transitory computer-readable storage medium of claim 19, wherein the one or more predicted mobile asset reservation attributes include one or more of a reservation time interval, a vehicle location, or a vehicle type.
